(19) United States
(12) Patent Application Publication
(10) Pub. No.: US 2015/0168141 A1
(43) Pub. Date: Jun. 18, 2015

(54) ELECTRONIC DEVICE, MEASUREMENT DATA PROCESSING METHOD, AND MEASUREMENT DATA PROCESSING PROGRAM

(71) Applicant: SEIKO INSTRUMENTS INC., Chiba-shi (JP)

(72) Inventors: Kazuo KATO, Chiba-shi (JP); Keisuke TSUBATA, Chiba-shi (JP); Hisao NAKAMURA, Chiba-shi (JP); Tomohiro IHASHI, Chiba-shi (JP); Takanori HASEGAWA, Chiba-shi (JP); Katsuya MUGISHIMA, Chiba-shi (JP); Akira TAKAKURA, Chiba-shi (JP)

(21) Appl. No.: 14/540,531

(22) Filed: Nov. 13, 2014

(30) Foreign Application Priority Data
Dec. 13, 2013 (JP) 2013-258392

(51) Int. Cl. G01C 5/00; G01P 3/00

(52) U.S. Cl. CPC G01C 5/00; G01P 3/00

(57) ABSTRACT

An electronic device includes an altitude measurement unit, an altitude change determination unit, and an elevating speed calculator. The altitude measurement unit measures an altitude, the altitude change determination unit determines whether a change state of the altitude measured by the altitude measurement unit is at least an ascending state or a descending state, and the elevating speed calculator calculates an average elevating speed in each change state determined by the altitude change determination unit based on the altitude measured by the altitude measurement unit. A data processing method in the electronic device and a data processing program executed by a computer of the electronic device may be realized.

### BACKGROUND OF THE INVENTION

1. Field of the Invention

The present invention relates to an electronic device, a measurement data processing method, and a measurement data processing program.

2. Background Art

In the related art, an altimeter that measures an atmospheric pressure and detects an altitude at that time point based on the measured atmospheric pressure, or an electronic device that has such a function has been developed. The electronic device may be used for outdoor exercise performed in a mountain place where undulation or sloping is noticeable, such as mountain climbing or hiking. The electronic device calculates an average ascending speed or an average descending speed based on a detected altitude. In the following description, the ascending speed and the descending speed are collectively referred to as an elevating speed.

An average elevating speed calculated by an electronic watch with a pressure sensor disclosed in JP-A-63-121778 is a value obtained by dividing a current altitude (relative altitude) with reference to an altitude at a measurement start time point by an elapsed time to a current time. Further, an electronic altimeter disclosed in Japanese Patent No. 3131852 accumulates an elapsed time only when a difference between a currently measured altitude and a previously measured altitude is detected as a predetermined value or greater, and calculates an elevating speed using the accumulated elapsed time.

However, since an ascending section and a descending section are mixed on a path through which a user moves from the measurement start time point, an ascending altitude and a descending altitude are canceled out. Thus, in the electronic watch with the pressure sensor disclosed in JP-A-63-121778 or the electronic altimeter disclosed in Japanese Patent No. 3131852, the calculated average elevating speed may be lower than an actual average elevating speed. If the user determines the user's own walking pace based on the calculated average elevating speed lower than the actual average elevating speed, the walking pace may be a pace (over-pace) faster than a walking pace that assigns a target average elevating speed. Further, when a departure at the measurement start time point is the same as a destination at a measurement end time point, such as in mountain climbing for a day, since a cumulative altitude becomes zero, only insignificant information indicating an average elevating speed of zero is obtained. Further, in mountain climbing, a descending speed is significantly high compared with an ascending speed. For example, the descending speed is about two times the ascending speed. Thus, in pace management of mountain climbing, hiking or the like, it is preferable that the ascending speed and the descending speed be distinguishingly calculated.

JP-A-05-172569 discloses an altitude measurement device that includes altitude detection means for sequentially detecting a current altitude at a predetermined timing, altitude difference calculation means for calculating a difference between a detected current altitude and a previous altitude, determination means for determining an altitude change direction based on the calculated difference, and accumulation means for accumulating the calculated difference in at least one of the respective altitude change directions based on the determination result. However, the altitude measurement device disclosed in JP-A-05-172569 simply accumulates the altitude change detected in each altitude change direction, which does not calculate an elevating speed.

### SUMMARY OF THE INVENTION

Thus, in order to solve the above problems, an object of the invention is to provide an electronic device capable of distinguishingly calculating an average ascending speed and an average descending speed, and a measurement data processing method and a measurement data processing program.

According to an aspect of the invention, there is provided an electronic device including: an altitude measurement unit that measures an altitude; an altitude change determination unit that determines whether a change state of the altitude measured by the altitude measurement unit is at least an ascending state or a descending state; and an elevating speed calculator that calculates an average elevating speed in each change state determined by the altitude change determination unit based on the altitude measured by the altitude measurement unit.

According to another aspect of the invention, in the above-described electronic device, the elevating speed calculator calculates the average elevating speed in each change state based on displacement of an altitude and an elapsed time in each section where the change state determined by the altitude change determination unit is constant.

According to still another aspect of the invention, in the above-described electronic device, the elevating speed calculator calculates an elevating speed at each predetermined sampling interval based on the altitude measured by the altitude measurement unit, accumulates the calculated elevating speed and the number of appearances with respect to the change state determined by the altitude change determination unit, and calculates the average elevating speed in each change state based on the accumulated elevating speed and number of appearances.

According to still another aspect of the invention, in the above-described electronic device, when an altitude that is higher than a predetermined first altitude range from a current altitude is included in a previous altitude within a predetermined determination interval before a current time and the previous altitude is within a second altitude range that is wider than the first altitude range, the altitude change determination unit determines that the change state is the descending state, when an altitude that is lower than the first altitude range is included in the previous altitude and the previous altitude is included in the second altitude range, the altitude change determination unit determines that the change state is the ascending state, and when the previous altitude is out of the second altitude range, the altitude change determination unit stops the accumulation of the elevating speed.

According to still another aspect of the invention, in the above-described electronic device, when a previous altitude measured by the altitude measurement unit at a time that is a predetermined time interval before a current time is within a range from an altitude that is lower than a current altitude by a predetermined first altitude to an altitude that is lower than the current altitude currently measured by the altitude measurement unit by a predetermined second altitude, the altitude change determination unit determines that the change state is the ascending state, when the previous altitude is within a range from an altitude that is higher than the current altitude by the first altitude to an altitude that is higher than the current altitude by the second altitude, the altitude change determination unit determines that the change state is the descending state, and when the previous altitude is an altitude that is lower than the altitude lower than the current altitude by the second altitude or is an altitude that is higher than the altitude higher than the current altitude by the second altitude, the elevating speed calculator stops the accumulation of the elevating speed.

According to still another aspect of the invention, in the above-described electronic device, the elevating speed calculator calculates a moving average of the calculated elevating speed, and stops the accumulation of the elevating speed until a moving average section elapses after the change state determined by the altitude change determination unit is changed.

According to still another aspect of the invention, there is provided a data processing method in an electronic device, including: determining whether a change state of an altitude measured by an altitude measurement unit is at least an ascending state or a descending state; and calculating an average elevating speed in each change state determined in the determining of the altitude change based on the altitude measured by the altitude measurement unit.

According to still another aspect of the invention, there is provided a data processing program that causes a computer of an electronic device to execute a procedure including: determining whether a change state of an altitude measured by an altitude measurement unit is at least an ascending state or a descending state; and calculating an average elevating speed in each change state determined in the determining of the altitude change based on the altitude measured by the altitude measurement unit.

According to the invention, an average ascending speed and an average descending speed can be distinguishingly calculated.

### BRIEF DESCRIPTION OF THE DRAWINGS

FIG. 1 is a front view illustrating an external configuration of an electronic device according to a first embodiment of the invention.

FIG. 2 is a block diagram schematically illustrating a configuration of the electronic device in the present embodiment.

FIG. 3 is a diagram illustrating a setting example of a detection window.

FIG. 4 is a diagram illustrating a setting example of a moving average interval.

FIG. 5 is a diagram illustrating an example of a measured altitude.

FIGS. 6A-6C are diagrams illustrating examples of information displayed by a display unit.

FIG. 7 is a flowchart illustrating data processing according to the present embodiment.

FIG. 8 is a flowchart illustrating data processing according to a second embodiment of the invention.

FIG. 9 is a diagram illustrating an example of a moving average of an elevating speed.

FIG. 10 is a flowchart illustrating data processing according to a third embodiment of the invention.

FIG. 11 is a flowchart illustrating a process of determining an altitude change state.

FIG. 12 is a diagram illustrating a setting example of a detection window.

FIG. 13 is a flowchart illustrating data processing according to a fourth embodiment of the invention.

### DETAILED DESCRIPTION OF THE INVENTION

### First Embodiment

Hereinafter, a first embodiment of the invention will be described with reference to the accompanying drawings. The same reference numerals are given to the same units in the respective drawings.

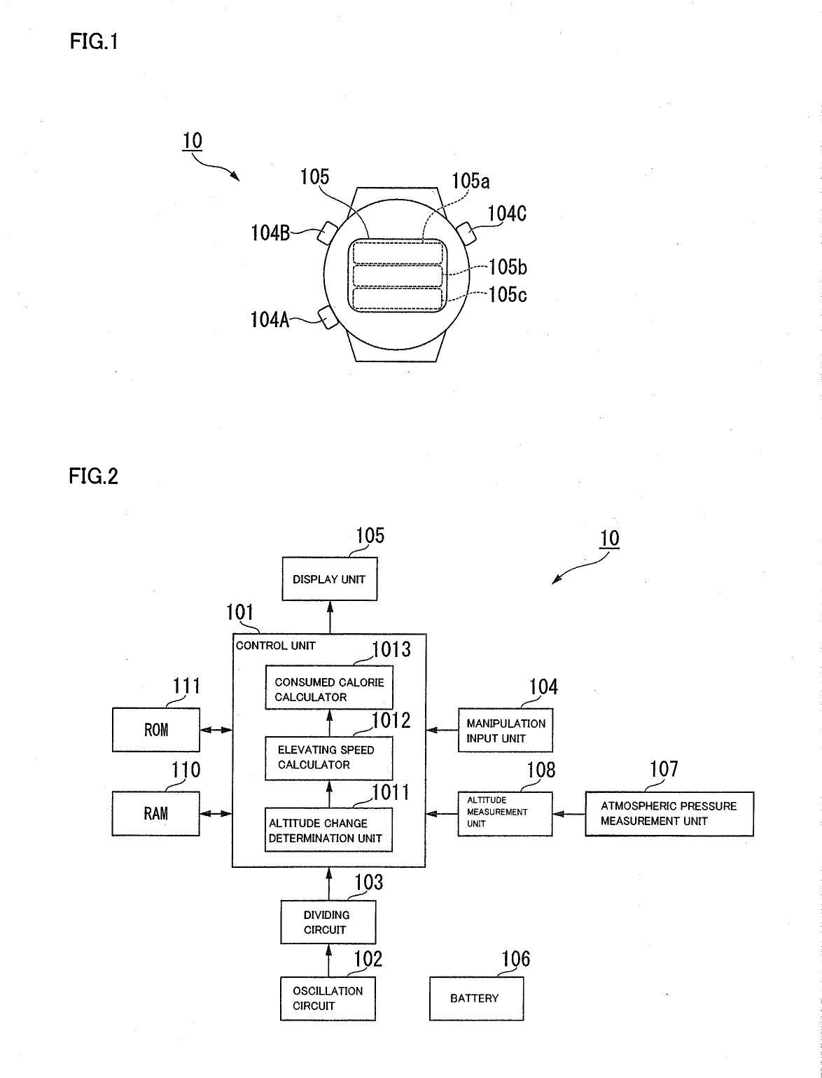

FIG. 1 is a front view illustrating an appearance configuration of an electronic device 10 in the present embodiment.

The electronic device 10 is an electronic watch with an altitude measurement function that measures an altitude, for example. The electronic device 10 measures current time and altitude and calculates an elevating speed based on the measured altitude.

The electronic device 10 includes a manipulation input unit 104 and a display unit 105.

The manipulation input unit 104 includes plural (in the present embodiment, three) key input means (manipulation input units) 104A, 104B, and 104C, for example. Each of the key input means 104A, 104B, and 104C has a button, receives a manipulation input, and outputs a manipulation signal based on the received manipulation input to a control unit 101.

The key input means 104A receives a manipulation of switching an operation mode by pressing the button, for example. The operation mode includes two modes of a “normal mode” in which a time, an altitude, and an elevating speed that are currently measured are displayed and an “altitude log mode” in which altitude information (for example, altitude and elevating speed) relating to the altitude is recorded, for example. The electronic device 10 is operated in the operation mode switched according to the manipulation.

The key input means 104B receives a manipulation of switching information to be displayed in the display unit 105 by pressing the button when the electronic device 10 is operated in the altitude log mode, for example. The displayed information includes “start time display”, “maximum altitude display”, and “current altitude display”, for example.

The start time display represents altitude information when altitude information recording is started. The maximum altitude display represents altitude information relating to the maximum altitude among altitudes indicated by the recorded altitude information. The current altitude display represents altitude information that is currently obtained when operated in the altitude log mode.

The key input means 104C receives a manipulation of switching information to be displayed in the display unit 105 by pressing the button. The displayed information includes “average ascending speed”, “average descending speed”, and “consumed calories”, for example.

The average ascending speed represents a cumulative average (CA) value from the start of measurement, of an elevating speed while the altitude change state is determined as an ascending state. The average descending speed represents a CA value from the start of measurement, of the elevating speed while the altitude change state is determined to be in a descending state. The consumed calories represent a calorific value (energy) consumed as a user moves from the start of measurement. The above-mentioned information may be displayed with character strings indicating the type of information, and the current time, altitude, or elevating speed.

The display unit 105 displays the obtained information. The display unit 105 may be a liquid crystal display, a segment display, or the like.

The display unit 105 includes a first display 105a, a second display 105b, and a third display 105c, for example.

FIG. 2 is a block diagram illustrating a configuration of the electronic device 10 according to the present embodiment.

The electronic device 10 includes a control unit 101, an oscillation circuit 102, a dividing circuit 103, the manipulation input unit 104, the display unit 105, a battery 106, an atmospheric pressure measurement unit 107, an altitude measurement unit 108, a random access memory (RAM) 110, and a read only memory (ROM) 111.

The control unit 101 controls the respective units of the electronic device 10. The control unit 101 is a central processing unit (CPU), for example.

The control unit 101 includes an altitude change determination unit 1011, an elevating speed calculator 1012, and a consumed calorie calculator 1013.

The altitude change determination unit 1011 determines an altitude change state based on altitude signals input from the altitude measurement unit 108 within a first predetermined time interval (for example, 5 minutes) before the current time.

The altitude change determination unit 1011 samples the altitudes indicated by the altitude signals input from the altitude measurement unit 108 at each predetermined time interval (sampling interval, for example, 1 minute) ΔT.

The altitude change state includes an “ascending state”, a “descending state”, and a “non-elevating state”, for example. The ascending state refers to a state where the altitude increases with lapse of time. The ascending state may appear when the user who holds the electronic device 10 walks on a mountain trail with a rising gradient, for example. The descending state may appear when the user who holds the electronic device 10 walks on, a mountain trail with a falling gradient, for example. The non-elevating state refers to a state where a significant altitude change does not appear, that is, a state that is neither the ascending state nor the descending state. The non-elevating state may appear when the user who holds the electronic device 10 walks on a flat area, or when the user is resting, for example. The altitude change determination unit 1011 outputs the sampled altitudes and altitude change state information indicating the determined altitude change state to the elevating speed calculator 1012. An example of a process of determining the altitude change state will be described later.

The elevating speed calculator 1012 calculates a moving average (MV) of the elevating speed based on the altitudes sampled by the altitude change determination unit 1011 within a second time interval before the current time, at each sampling interval. Here, the calculated moving average is a short time average (STA). The second time interval is a value (for example, 10 minutes) greater than the first time interval (for example, 5 minutes). The second time interval may be fixed as a predetermined value, or may be variable. When the second time interval is variable, if there is a possibility that the second time interval is set to be larger than the first time interval, the second time interval may be temporarily equal to the first time interval.

For example, when the altitude change state indicated by the altitude change state information input from the altitude change determination unit 1011 is changed, the elevating speed calculator 1012 reduces the second time interval to the first time interval, and then, enlarges the second time interval at the same progress level as the lapse of time until the second time interval reaches a predetermined third time interval (the maximum value of the second time interval). An example of a process of calculating the moving average of the elevating speed will be described later.

The elevating speed calculator 1012 accumulates a displacement of the altitude and an elapsed time in each section in which the altitude change state indicated by the altitude change state information input from the altitude change determination unit 1011 is constant in each altitude change state. The elevating speed calculator 1012 divides the cumulative value of the displacement of the altitude by the cumulative value of the elapsed time to calculate an average elevating speed in each altitude change state. The calculated average elevating speed may be referred to as a cumulative average elevating speed for distinction from the above-mentioned elevating speed.

When calculating the average elevating speed, the elevating speed calculator 1012 subtracts the altitude when the altitude change state starts at that time point from the altitude sampled by the altitude change determination unit 1011 at that time point to calculate the displacement of the altitude in a section at that time point (current section) at each sampling interval. The elevating speed calculator 1012 sets a time from the time when the altitude change state starts at that time point up to the current time as an elapsed time in the current section. When the altitude change state determined by the altitude change determination unit 1011 is changed, the elevating speed calculator 1012 stores the altitude change state of a section immediately before the current section (immediately previous section), the displacement of the altitude, and the elapsed time in the RAM 110 in association with each other. Further, the elevating speed calculator 1012 repeats the process of calculating the displacement of the altitude in the current section and determining the elapsed time.

The elevating speed calculator 1012 reads the altitude change state, the displacement of the altitude, and the elapsed time from the RAM 110 in each section from the time point when the altitude log mode is designated to the immediately previous section. The elevating speed calculator 1012 calculates the cumulative value of the displacement of the altitude and the cumulative value of the elapsed time using the total displacement of the altitude and the total elapsed time up to the current section in each altitude change state. The elevating speed calculator 1012 divides the cumulative value of the displacement of the altitude by the cumulative value of the elapsed time to calculate the average elevating speed in each altitude change state. The elevating speed calculator 1012 outputs the calculated average elevating speed in each altitude change state and the cumulative value of the elapsed time to the consumed calorie calculator 1013. An example of calculating the average elevating speed will be described later.

The consumed calorie calculator 1013 calculates the consumed calories based on the average elevating speed in each altitude change state and the cumulative value of elapsed time input from the elevating speed calculator 1012. For example, consumption amounts corresponding to sets of the altitude change states and the average elevating speeds are set in advance in the consumed calorie calculator 1013, from which a consumption amount corresponding to the input altitude change state and average elevating speed is specified. The consumption amount refers to a factor indicating consumed calories per unit time. The consumed calorie calculator 1013 may multiply the specified consumption amount in each altitude change state and the cumulative value of the elapsed time to calculate a multiplication value, and may calculate the consumed calories using the sum of the calculated multiplication values. The consumed calorie calculator 1013 stores the calculated consumed calories in the RAM 110.

The consumption amount is a positive value depending on the altitude change state and the elevating speed. The consumption amount increases as the average elevating speed (that is, average ascending speed) in the ascending state increases, and decreases as the average elevating speed (that is, average descending speed) in the descending state decreases. The consumption amount relating to the average elevating speed (that is, 0) in the non-elevating state is set to a positive value between the consumption amount relating to the average ascending speed and the consumption amount relating to the average descending speed.

Further, the consumption amount varies according to body information such as weight, gender or height of the user. Thus, the body information and the consumption amount may be stored in advance in the consumed calorie calculator 1013 in association with each other, any one of the pieces of the body information may be selected according to a manipulation signal input from the manipulation input unit 104, and the consumption amount corresponding to the selected piece of body information may be used to calculate the consumed calories.

The control unit 101 counts the current time based on a measurement signal input from the dividing circuit 103. When the electronic device 10 is operated in the normal mode, the control unit 101 outputs the time information indicating the counted current time and the generated altitude information to the display unit 105, and allows the display unit 105 to display the current time, altitude, and elevating speed. Even when the electronic device 10 is operated in the altitude log mode, when the manipulation signal is not input from the key input means 104B, the control unit 101 may allow the display unit 105 to display the current time, altitude and elevating speed.

The control unit 101 performs the process based on the manipulation signal input from the manipulation input unit 104. For example, when the electronic device 10 is operated in the normal mode, if the manipulation signal (altitude log mode) is input from the key input means 104A, the control unit 101 switches the operation mode from the normal mode to the altitude log mode and starts the operation in the above-mentioned altitude log mode. In the altitude log mode, the elevating speed calculator 1012 generates altitude information indicating the altitudes sampled in the altitude change determination unit 1011 and the moving average of the calculated elevating speed. The elevating speed calculator 1012 stores the time information indicating the current time at that time point and the generated altitude information in the RAM 110 in association with each other at a predetermined time interval.

Further, when the electronic device 10 is operated in the altitude log mode, if the manipulation signal (normal mode) is input from the key input means 104A, the control unit 101 switches the operation mode from the altitude log mode to the normal mode to stop the recording of the altitude information. Further, the control unit 101 records average elevating speed information indicating the cumulative average elevating speed in each altitude change state calculated up to that time point in the RAM 110.

When the electronic device 10 is operated in the altitude log mode to display the currently obtained altitude information, if the manipulation signal (start time display) is input from the key input means 104B, the control unit 101 reads the altitude information at the time point (start time) when the recording starts from the RAM 110. The control unit 101 outputs the read altitude information to the display unit 105 to be displayed.

When the electronic device 10 is operated in the altitude log mode to display the altitude information at the start time, if the manipulation signal (maximum altitude display) is input from the key input means 104B, the control unit 101 reads the altitude information relating to the maximum altitude from the RAM 110. The control unit 101 outputs the read altitude information to the display unit 105 to be displayed.

When the electronic device 10 is operated in the altitude log mode to display the altitude information relating to the maximum altitude, if the manipulation signal (current altitude display) is input from the key input means 104B, the control unit 101 outputs the current altitude information to the display unit 105 to be displayed, similar to the normal mode.

If the manipulation signal (average ascending speed) is input from the key input means 104C, for example, the control unit 101 reads the average elevating speed (average ascending speed) associated with the ascending state as the altitude change state from the RAM 110. The control unit 101 outputs the read average ascending speed to the display unit 105 to be displayed.

When the average ascending speed is displayed, if the manipulation signal (average descending speed) is input from the key input means 104C, the control unit 101 reads the average elevating speed (average descending speed) associated with the descending state as the altitude change state from the RAM 110. The control unit 101 outputs the read average descending speed to the display unit 105 to be displayed.

When the average descending speed is displayed, if the manipulation signal (consumed calories) is input from the key input means 104C, the control unit 101 reads the consumed calories from the RAM 110. The control unit 101 outputs the read consumed calories to the display unit 105 to display the consumed calories. When the consumed calories are calculated at that time point, the control unit 101 may output the calculated consumed calories to the display unit 105.

If the time period when the average ascending speed, the average descending speed or the consumed calories is displayed exceeds a predetermined time threshold (for example, 10 seconds), the control unit 101 may allow the display unit 105 to display the current time, altitude, and elevating speed, similar to the normal mode.

The oscillation circuit 102 generates an oscillation signal of a predetermined frequency (oscillation frequency of, for example, 32768 Hz), and outputs the generated oscillation signal to the dividing circuit 103.

The dividing circuit 103 divides the oscillation frequency of the oscillation signal input from the oscillation circuit 102 to generate a measurement signal of a predetermined frequency (clock frequency of, for example, 100 Hz) that is a measurement reference.

The battery 106 supplies power for operation to the respective units that form the electronic device 10.

The atmospheric pressure measurement unit 107 measures atmospheric pressure, and outputs an atmospheric pressure signal indicating the measured atmospheric pressure to the altitude measurement unit 108. The atmospheric pressure measurement unit 107 is an atmospheric pressure sensor, for example.

The altitude measurement unit 108 measures the altitude based on the atmospheric pressure signal input from the atmospheric pressure measurement unit 107, and outputs an altitude signal indicating the measured altitude to the control unit 101. When measuring the altitude, the altitude measurement unit 108 converts the atmospheric pressure P indicated by the input atmospheric pressure signal into the altitude h using Expression (1), for example.

h={(P₀/P)^{(1/5.257)}−1}·(T+273.15)/0.0065 (1)

In Expression (1), P₀ represents atmospheric pressure 1013 hPa at a predetermined elevation, for example, at an elevation of 0 m (height above sea level). T represents temperature (° C.).

The atmospheric pressure measurement unit 107 and the altitude measurement unit 108 form an altimeter that measures the altitude.

The RAM 110 stores data used for operation in the respective units of the electronic device 10, and data generated in the respective units. The RAM 110 stores the altitude information as a log file, for example.

An operation program to be executed by the control unit 101 is stored in advance in the ROM 111. The operation program is read when starting the control unit 101, and the control unit 101 executes a designated process by the read operation program.

Next, an example of the process of determining the altitude change state by the altitude change determination unit 1011 will be described.

In the following description, an altitude sampled at a certain time point is referred to as a “current altitude”, and an altitude sampled before the current altitude is referred to as a “previous altitude”. Further, each of the times when the sampling is performed may be referred to as a “sampling time”.

The altitude change determination unit 1011 determines the altitude change state based on the altitudes sampled in a section from a time t−ΔT1 that is a predetermined first time interval ΔT1 before a current time t to the current time t. In the following description, the section from the time t−ΔT1 to the current time t is referred to as a “determination section”.

Here, the altitude change determination unit 1011 may compare a distribution of the altitudes sampled within the determination section with a predetermined altitude range around a current altitude h to determine the altitude change state.

For example, when all of the altitudes sampled within the determination section is within a range between a predetermined lower limit value and a predetermined upper limit value, the altitude change determination unit 1011 determines that the altitude change state at the current time t is the non-elevating state. In the following description, the lower limit value and the upper limit value are referred to as a “state determination lower limit value” and a “state determination upper limit value”, respectively.

The state determination lower limit value is a value h−Δh that is lower by a predetermined altitude Δh than the current altitude h, for example. The state determination upper limit value is a value h+Δh that is higher by the predetermined altitude Δh than the current altitude h, for example.

For example, when at least one of the altitudes sampled within the determination section is lower than the state determination lower limit value, the altitude change determination unit 1011 determines that the altitude change state at the current time t is the ascending state.

For example, when at least one of the altitudes sampled within the determination section is higher than the state determination upper limit value, the altitude change determination unit 1011 determines that the altitude change state at the current time t is the descending state.

The altitudes sampled within the determination section may include both the altitudes lower than the state determination lower limit value and the altitudes higher than the state determination upper limit value. In this case, the altitude change determination unit 1011 may determine the altitude change state at the current time t based on the altitude at time t′ closest to the current time t, among the altitudes lower than the state determination lower limit value and the altitudes higher than the state determination upper limit value. That is, if the altitude at time t′ is lower than the state determination lower limit value, the altitude change determination unit 1011 determines that the altitude change state at the current time t is the ascending state. If the altitude at time t′ is higher than the state determination upper limit value, the altitude change determination unit 1011 determines that the altitude change state at the current time t is the descending state.

Further, the altitude change determination unit 1011 may compare the number of the altitude samples lower than the state determination lower limit value, included in the altitudes sampled within the determination section, with the number of the altitude samples higher than the state determination upper limit value to determine the altitude change state at the current time t. That is, if the number of the altitude samples lower than the state determination lower limit value is greater than the number of the altitude samples higher than the state determination upper limit value, the altitude change determination unit 1011 determines that the altitude change state is the ascending state. If the number of the altitude samples lower than the state determination lower limit value is equal to the number of the altitude samples higher than the state determination upper limit value, the altitude change determination unit 1011 determines that the altitude change state is the non-elevating state. If the number of the altitude samples lower than the state determination lower limit value is smaller than the number of the altitude samples higher than the state determination upper limit value, the altitude change determination unit 1011 determines that the altitude change state is the descending state.

In addition, the altitude change determination unit 1011 may determine that the altitude change state is the ascending state when the average value of the altitudes sampled in the determination section is lower than the state determination lower limit value, may determine that the altitude change state is the descending state when the average value of the altitudes sampled in the determination section is higher than the state determination upper limit value, and may determine that the altitude change state is the non-elevating state in other cases.

In this way, by comparing the distribution of the altitudes sampled within the determination section with the predetermined altitude range around the current altitude, the altitude change state can be stably determined without receiving the influence of a measurement error or noise.

The altitude change determination unit 1011 outputs the altitude change state information indicating the determined altitude change state and the sampled altitudes to the elevating speed calculator 1012.

The altitude change state information may be represented as values based on the respective altitude change states. For example, the ascending state, the descending state, and the non-elevating state may be represented as values of “+1”, “−1”, and “0”, respectively.

In the following description, a range defined by the section (that is, the determination section) from the time t−ΔT1 that is the first time interval ΔT1 before the current time t to the current time t, in the time period when the altitude is within a range from the state determination lower limit value to the state determination upper limit value, may be referred to as a “detection window”.

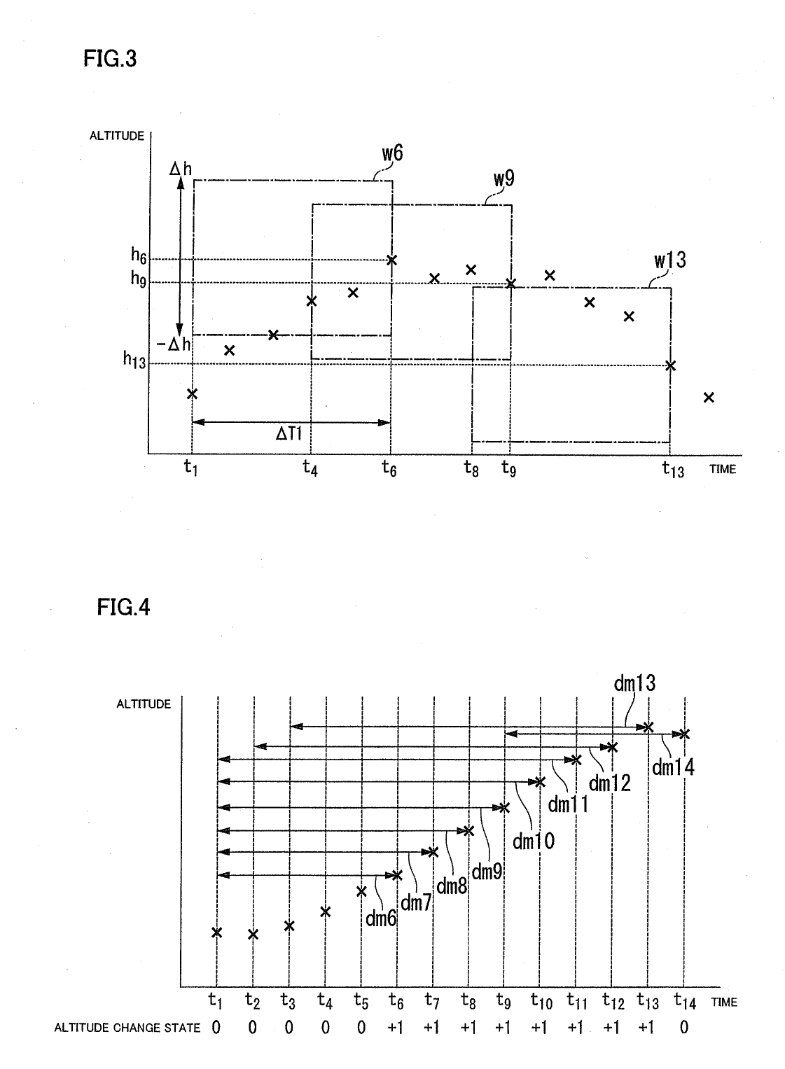

FIG. 3 is a diagram illustrating a setting example of the detection window.

The longitudinal axis and the transverse axis in FIG. 3 represent altitude and time, respectively.

X represents the altitude sampled at each sampling time, and rectangles indicated by one-dot chain lines respectively represent detection windows w6, w9, and w13. The detection window w6 represents a determination section of which a time range is from t₁ to t₆ and an altitude range is from h₆−Δh to h₆+Δh. Here, h₆ represents the altitude at sampling time t₆. The detection window w6 includes altitudes h₃ to h₆ among altitudes h₁ to h₆ sampled in the determination section. Here, the altitudes h₁ and h₂ are respectively lower than those of the detection window w6. Accordingly, the altitude change determination unit 1011 determines that the altitude change state at time t₆ is the “ascending state”.

The detection window w9 represents a determination section of which a time range is from t₄ to t₉ and an altitude range is from h₉−Δh to h₉+Δh. Here, h₉ represents the altitude at sampling time t₉. The detection window w9 includes all of altitudes h₄ to h₉ sampled in the determination section. Accordingly, the altitude change determination unit 1011 determines that the altitude change state at time t₉ is the “non-elevating state”.

The detection window w13 represents a determination section of which a time range is from t₈ to t₁₃ and an altitude range is from h₁₃−Δh to h₁₃+Δh. Here, h₁₃ represents the altitude at sampling time t₁₃. The detection window w13 includes altitudes h₁₁ to h₁₃ among altitudes h₈ to h₁₃ sampled in the determination section. The altitudes h₈ to h₁₀ are respectively higher than those of the detection window w13. Accordingly, the altitude change determination unit 1011 determines that the altitude change state at time t₁₃ is the “descending state”.

In the example shown in FIG. 3, the determined altitude change state is changed in the order of the “ascending state”, the “non-elevating state”, and the “descending state”, but the altitude change state may be changed from the “ascending state” to the “descending state” or may be changed from the “descending state” to the “ascending state”.

The altitude change determination unit 1011 may compare the current altitude h with an altitude hₜ−ΔT1 at the time t−ΔT1 that is the first time interval ΔT1 before the current time t to determine the altitude change state. For example, when the difference between the current altitude h and the altitude hₜ−ΔT1 at the time t−ΔT1 is greater than a positive threshold value that is a predetermined altitude difference, the altitude change determination unit 1011 determines that the altitude change state is the “ascending state”. Further, when the difference between the current altitude h and the altitude hₜ−ΔT1 at the time t−ΔT1 is smaller than a negative threshold value that is a predetermined altitude difference, the altitude change determination unit 1011 determines that the altitude change state is the “descending state”. In other cases, the altitude change determination unit 1011 determines that the altitude change state is the “non-elevating state”. Since the number of altitudes used for determination of the altitude change state is limited to two, the altitude change determination unit 1011 can determine the altitude change state by a simple process, and can suppress increase in a hardware scale.

Next, an example of the process of calculating the elevating speed by the elevating speed calculator 1012 will be described.

The altitudes sampled at each sampling interval ΔT are input to the elevating speed calculator 1012 from the altitude change determination unit 1011. The elevating speed calculator 1012 subtracts the immediately previous altitude from the currently input altitude to calculate the difference of the current altitude. The immediately previous altitude refers to an altitude sampled immediately before the current altitude. The elevating speed calculator 1012 divides the calculated difference by the sampling interval ΔT to calculate the current speed.

The elevating speed calculator 1012 calculates an average (moving average) of the elevating speed calculated in each sampling in the section from a starting point time to the current time t. The starting point time corresponds to a time t−ΔT2 that is a second time interval ΔT2 before the current time t. In this way, by calculating the moving average, the elevating speed in each sampling time is smoothened. In the following description, the section from the previous time t−ΔT2 to the current time t is referred to as a “moving average section”, and the length ΔT2 of the moving average section is referred to as a “moving average section length”.

Here, the elevating speed calculator 1012 determines whether the current altitude change state is changed from the immediately previous altitude change state based on the altitude change state information input from the altitude change determination unit 1011. If it is determined that the altitude change state is changed, the elevating speed calculator 1012 reduces the moving average section length to the first time interval ΔT1. That is, the moving average section length (second time interval ΔT2) may be temporarily equal to the first time interval ΔT1, but in other cases, the moving average section length may be greater than the first time interval ΔT1.

If it is determined that the altitude change state is changed, the elevating speed calculator 1012 may temporarily set the moving average section length to be shorter than the first time interval ΔT1. “Temporarily” represents “at a sampling time when the change of the altitude change state is determined” or “at a time when a predetermined time (for example, the first time interval) elapses from the sampling time”. Further, the time interval that is shorter than the first time interval may include at least two samples, that is, the current sampling time and the immediately previous sampling time.

Thus, when the altitude change state is changed, by reducing the moving average section length, a response until the moving average value of the elevating speeds is displayed can be improved. Further, since the previous elevating speed up to the time that is the moving average section length before the current time, that is, the elevating speed before the altitude change state is changed is ignored, a moving average value suitable for an actual feeling of the user based on the altitude change state at that time point is obtained. Particularly, this is efficient when the altitude change state is changed from the ascending state to the descending state, or vice versa.

If it is determined that the altitude change state is not changed, the elevating speed calculator 1012 determines whether the moving average section length reaches a predetermined third time interval (maximum value of the second time interval). If it is determined that the moving average section length reaches the third time interval, the elevating speed calculator 1012 does not change the moving average section length. If it is determined that the moving average section length does not reach the third time interval, the elevating speed calculator 1012 enlarges the progress of the moving average section length the same as that of the lapse of time. The elevating speed calculator 1012 does not change the sampling time that is a starting point of the moving average section, and sets an end point of the moving average section as the current sampling time.

Since the altitude change state information is not present immediately after the electronic device 10 starts, the elevating speed calculator 1012 may set the current elevating speed to 0. Further, when the current time is within the first time interval from the start, the elevating speed calculator 1012 may average the elevating speeds sampled from the start to the current time to determine the current elevating speed. At this time, the altitude change determination unit 1011 may not determine the altitude change state.

FIG. 4 is a diagram illustrating a setting example of a moving average section.

In FIG. 4, an altitude sampled at each sampling time is indicated by x, and moving average sections relating to sampling times t₆ to t₁₄ are respectively indicated by arrows dm6 to dm14 in the horizontal direction. The longitudinal axis and the transverse axis in FIG. 4 represent altitude and time, respectively. At the lower end of the transverse axis, a value of an altitude change state at each sampling time is shown. Here, +1, 0, and −1 represent the ascending state, the non-elevating state, and the descending state, respectively. In the example shown in FIG. 4, the first time interval and the third time interval are 5 samples and 10 samples, respectively.

FIG. 4 shows that the altitude change state is the non-elevating state (0) from sampling time t₁ to sampling time t₅, the altitude change state is the ascending state (+1) from sampling time t₆ to sampling time t₁₃, and the altitude change state is the non-elevating state (0) at sampling time t₁₄.

The arrow dm6 represents that the moving average section at sampling time t₆ includes sections of five samples from t₁ to t₆.

The arrows dm7 to dm11 represent that the moving average section length is enlarged at each of sampling times t₇ to t₁₁ by one sample at the same progress level as the lapse of time. With respect to the respective arrows dm7 to dm11, the starting points of the moving average sections are the same as the starting point (sampling time t₁) of the moving average section relating to the arrow dm6. Meanwhile, end points of the moving average sections that are respectively indicated by the arrows dm7 to dm11 become current times (sampling times t₇ to t₁₁) at the respective time points. This is because the elevating speed calculator 1012 determines that there is no change in the altitude change state and the moving average section length does not reach the third time interval.

The arrows dm12 and dm13 represent that the moving average section lengths, which are 10 samples, are constant at the respective sampling times t₁₂ and t₁₃, and the moving average sections shift so that end points of the moving average sections become current times at the respective time points. This is because the elevating speed calculator 1012 determines that there is no change in the altitude change state and the moving average section length reaches the third time interval.

The arrow dm14 represents that the moving average section at sampling time t₁₄ includes sections of five samples from t₉ to t₁₄. This is because the moving average section length is reduced to the first time interval as the elevating speed calculator 1012 detects that the altitude change state is changed from the non-elevating state to the ascending state.

In the example shown in FIG. 4, the moving average section length reaches the third time interval, and then, the moving average section length is reduced to the first time interval as the altitude change state is changed, but the invention is not limited thereto. For example, even before the moving average section length reaches the third time interval, the moving average section length may be reduced to the first time interval as the altitude change state is changed.

Next, an example of the process of calculating the average elevating speed by the elevating speed calculator 1012 will be described.

As described above, the elevating speed calculator 1012 specifies the displacement of the altitude and the elapsed time in each section in which the altitude change state indicated by the altitude change state information is constant. The elevating speed calculator 1012 accumulates the specified displacement of the altitude and the specified elapsed time, from the time point when the operation in the altitude log mode is started to the current section, in each altitude change state to calculate the cumulative value of the displacement of the altitude and the cumulative value of the elapsed time. The elevating speed calculator 1012 divides the cumulative value of the displacement of the altitude by the cumulative value of the elapsed time to calculate an average elevating speed in each altitude change state.

FIG. 5 is a diagram illustrating an example of the measured altitude.

The longitudinal axis and the transverse axis in FIG. 5 represent altitude and time, respectively. The altitude change state is shown at the lower end of the transverse axis. Sections where the altitude change states are constant are divided by vertical dashed lines. A black circle and a white circle in FIG. 5 respectively represent the time point (starting point) when the operation in the altitude log mode is started and the current time point (end point).

The altitude first ascends with the lapse of time and then descends to thus have a first maximum point. T₁ represents an elapsed time of the section from the starting point to the first maximum point, and in this section, the altitude change state is the ascending state (+1). H₁ represents the displacement of the altitude in this section. Then, the altitude descends with the lapse of time and then ascends to thus have a first minimum point. T₂ represents an elapsed time of the section from the first maximum point to the first minimum point, and in this section, the altitude change state is the descending state (−1). H₂ represents the displacement of the altitude in this section.

Then, the altitude ascends with the lapse of time and then descends to thus have a second maximum point. T₃ represents an elapsed time of the section from the first minimum point to the second maximum point, and in this section, the altitude change state is the ascending state (+1). H₃ represents the displacement of the altitude in this section.

Then, the altitude descends with the lapse of time and then ascends to thus have a second minimum point. T₄ represents an elapsed time of the section from the second maximum point to the second minimum point, and in this section, the altitude change state is the descending state (−1). H₄ represents the displacement of the altitude in this section.

Then, the altitude ascends with the lapse of time and then becomes approximately constant to thus have a first inflection point. T₅ represents an elapsed time of the section from the second minimum point to the first inflection point, and in this section, the altitude change state is the ascending state (+1). H₅ represents the displacement of the altitude in this section.

Then, the altitude becomes approximately constant regardless of the lapse of time and then ascends to thus have a second inflection point. T₆ represents an elapsed time of the section from the first inflection point to the second inflection point, and in this section, the altitude change state is the non-elevating state (0). The displacement of the altitude in this section becomes 0.

Then, the altitude ascends with the lapse of time and then descends to thus have a third maximum point. T₇ represents an elapsed time of the section from the second inflection point to the third maximum point, and in this section, the altitude change state is the ascending state (+1). H₇ represents the displacement of the altitude in this section.

Then, the altitude descends with the lapse of time to reach the current point. T₈ represents an elapsed time of the section from the third maximum point to the current point, and in this section, the altitude change state is the descending state (−1). H₈ represents the displacement of the altitude in this section.

In this case, with respect to the ascending state, the elevating speed calculator 1012 calculates the cumulative value of the displacement of the altitude as H₁+H₃+H₅+H₇, and calculates the cumulative value of the elapsed time as T₁+T₃+T₅+T₇. Further, with respect to the descending state, the elevating speed calculator 1012 calculates the cumulative value of the displacement of the altitude as H₂+H₄+H₈, and calculates the cumulative value of the elapsed time as T₂+T₄+T₈. With respect to the non-elevating state, the elevating speed calculator 1012 calculates the cumulative value of the elapsed time as T₆. In this case, the displacement of the altitude does not occur.

Accordingly, the elevating speed calculator 1012 calculates an average ascending speed “vᵤ” with respect to the ascending state as (H₁+H₃+H₅+H₇)/(T₁+T₃+T₅+T₇), and calculates an average descending speed “v_{d}” with respect to the descending state as (H₂+H₄+H₈)/(T₂+T₄+T₈).

Next, an example of the information displayed by the display unit 105 will be described.

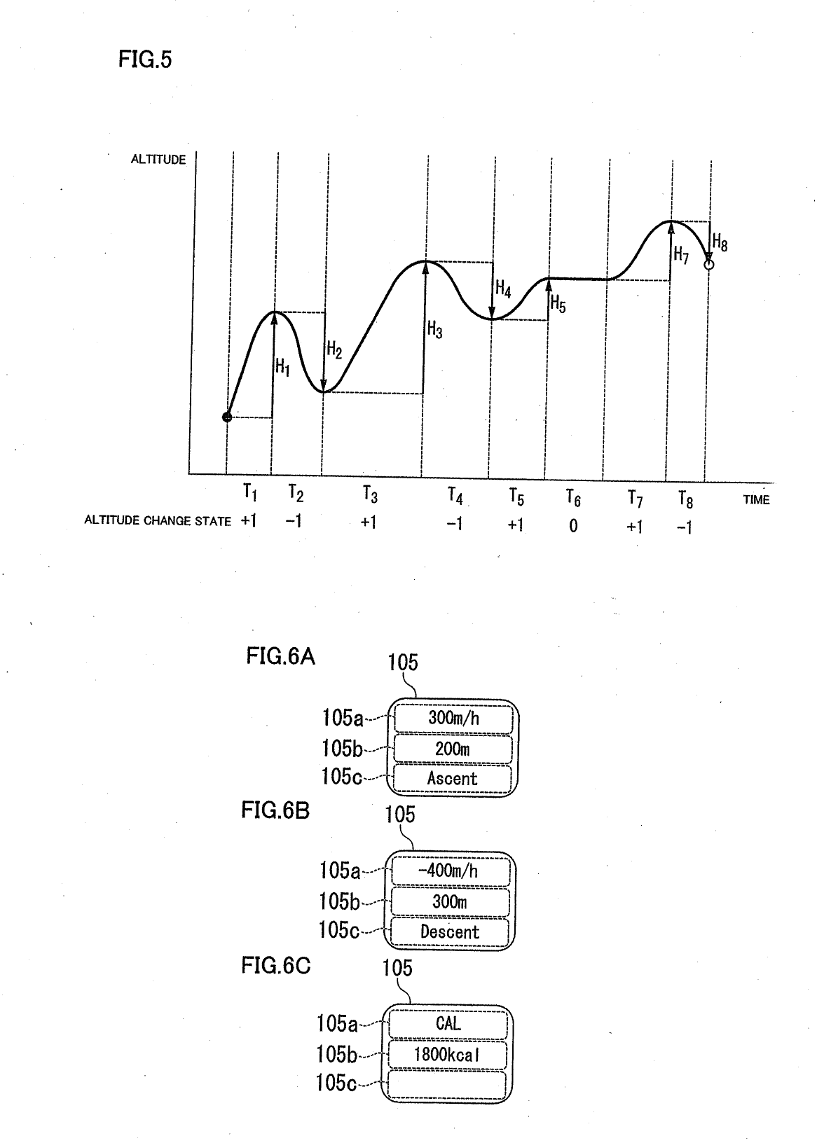

FIGS. 6A-6C show examples of the information displayed by the display unit 105.

The example shown in FIG. 6A is an example of an average ascending speed displayed when the key input means 104C is pressed. Here, the display unit 105 displays an average ascending speed “300 m/h” in the first display 105a, displays a current altitude “200 m” in the second display 105b, and displays an altitude change state “Ascent” in the third display 105c. Here, “Ascent” is a character string indicating the ascending state.

The example shown in FIG. 6B is an example of an average descending speed displayed when the key input means 104C is pressed. Here, the display unit 105 displays an average descending speed “−400 m/h” in the first display 105a, displays a current altitude “300 m” in the second display 105b, and displays an altitude change state “Descent” in the third display 105c. Here, “Descent” is a character string indicating the descending state.

The example shown in FIG. 6C is an example of consumed calories displayed when the key input means 104C is pressed. Here, the display unit 105 displays a character string “CAL” indicating the consumed calories in the first display 105a, and displays consumed calories “1800 kcal” in the second display 105b. In this case, nothing is displayed in the third display 105c.

In FIGS. 6A to 6C, at least the average ascending speed, the average descending speed, and the consumed calories are respectively displayed, and the display of the current altitude, “Ascent”, or the like may be omitted. Further, in FIGS. 6A and 6B, a current time may be displayed instead of the character string indicating the altitude change state. Further, in FIG. 6C, a current time may be displayed in the third display 105c.

Next, data processing according to the present embodiment will be described.

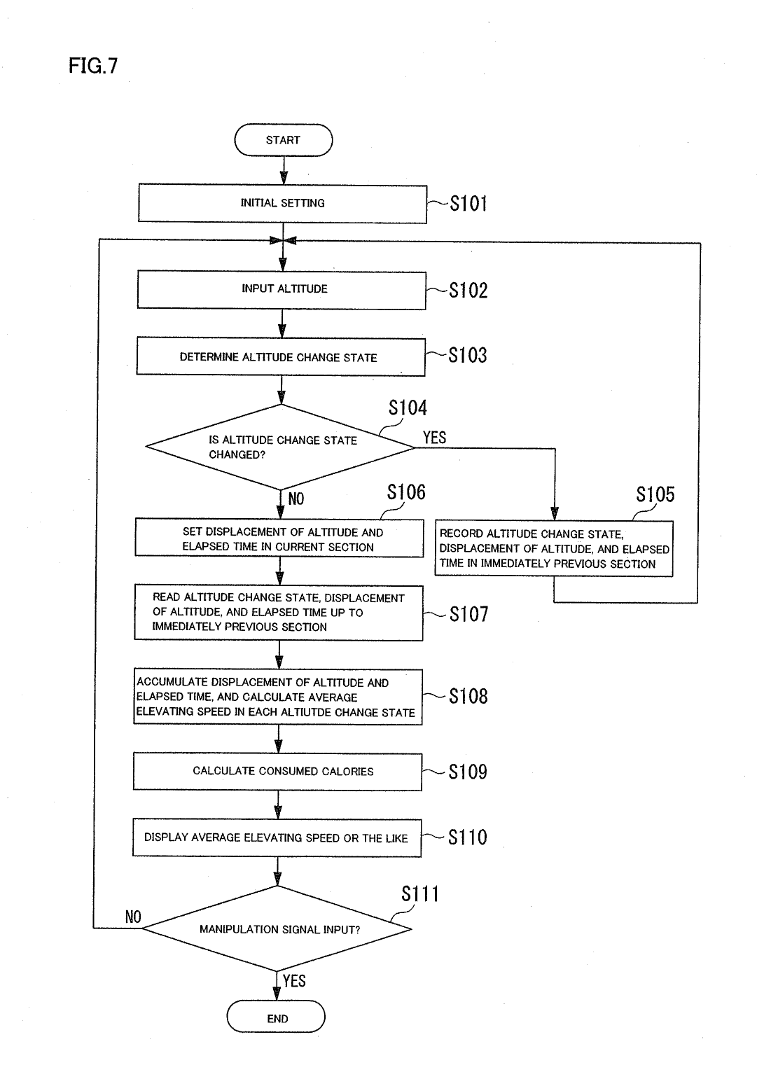

FIG. 7 is a flowchart illustrating data processing according to the present embodiment.

In step S101, the control unit 101 designates the altitude log mode as the manipulation signal is input from the key input means 104A, to perform initial setting. For example, the elevating speed calculator 1012 respectively sets the cumulative value of the displacement of the altitude and the cumulative value of the elapsed time in each altitude change state to 0. Then, the procedure proceeds to step S102.

In step S102, the altitude change determination unit 1011 samples the altitude indicated by the altitude signal input from the altitude measurement unit 108 at each predetermined time interval ΔT. Then, the procedure proceeds to step S103.

In step S103, the altitude change determination unit 1011 determines the altitude change states based on the altitudes sampled within the determination section from the previous time t−ΔT₁ to the current time t. If the altitudes sampled within the determination section are within the range between the state determination lower limit value and the state determination upper limit value, the altitude change determination unit 1011 determines that the altitude change state at the current time t is the non-elevating state. For example, if at least one of the altitudes sampled within the determination section is lower than the state determination lower limit value, the altitude change determination unit 1011 determines that the altitude change state at the current time t is the ascending state. For example, if at least one of the altitudes sampled within the determination section is higher than the state determination upper limit value, the altitude change determination unit 1011 determines that the altitude change state at the current time t is the descending state.

The altitude change determination unit 1011 outputs the altitude change state information indicating the determined altitude change state to the elevating speed calculator 1012. Then, the procedure proceeds to step S104.

In step S104, the elevating speed calculator 1012 determines whether the current altitude change state is changed from the immediately previous altitude change state based on the altitude change state information input from the altitude change determination unit 1011. If it is determined that the current altitude change state is changed (Yes in step S104), the procedure proceeds to step S105. If it is determined that the current altitude change state is not changed (No in step S104), the procedure proceeds to step S106.

In step S105, the elevating speed calculator 1012 stores the altitude change state, the displacement of the altitude, and the elapsed time in the immediately previous section in the RAM 110 in association with each other. Then, the procedure returns to step S102.

In step S106, the elevating speed calculator 1012 subtracts the altitude when the current section is started from the altitude sampled by the altitude change determination unit 1011 from the time point when the altitude log mode is designated, to calculate the displacement of the altitude in the current section. Further, the elevating speed calculator 1012 sets the time period from the time when the current section is started to the current time as the elapsed time in the current section. Then, the procedure proceeds to step S107.

In step S107, the elevating speed calculator 1012 reads the altitude change state, the displacement of the altitude, and the elapsed time up to the immediately previous section from the RAM 110. Then, the procedure proceeds to step S108.

In step S108, the elevating speed calculator 1012 calculates the cumulative value of the displacement of the altitude and the cumulative value of the elapsed time up to the current section in each altitude change state. The elevating speed calculator 1012 divides the cumulative value of the displacement of the altitude by the cumulative value of the elapsed time to calculate the average elevating speed in each altitude change state. Then, the procedure proceeds to step S109.

In step S109, the consumed calorie calculator 1013 specifies the consumption amount corresponding to the altitude change state and the average elevating speed. The consumed calorie calculator 1013 multiplies the specified consumption amount and the cumulative value of the elapsed time in each altitude change state to calculate the multiplication value, and calculates the consumed calories using the sum of the calculated multiplication values. Then, the procedure proceeds to step S110.

In step S110, when the manipulation signal is input from the key input means 104C, the control unit 101 periodically switches the average elevating speed or the like, for example, the average ascending speed, the average descending speed, and the consumed calories, to be displayed in the display unit 105.

In step S111, the control unit 101 determines whether the manipulation signal is input from the key input means 104A. If the manipulation signal is input (Yes in step S111), the control unit 101 determines that the normal mode is designated, and finishes the process shown in FIG. 7. If the manipulation signal is not input (No in step Sill), the procedure returns to step S102, and repeats the processes until step S111 at each sampling interval ΔT.

Even after the process shown in FIG. 7 is finished, the altitude change state, the displacement of the altitude, and the elapsed time in each section are recorded in the RAM 110, and thus, the electronic device 10 may execute steps S107 to S110 using the recorded altitude change state, the displacement of the altitude, and the elapsed time. That is, as the manipulation signal is input from the key input means 104C, the elevating speed calculator 1012 may read the altitude change state, the displacement of the altitude, and the elapsed time in all the sections from the RAM 110. Further, the elevating speed calculator 1012 calculates the cumulative value of the displacement of the altitude and the cumulative value of the elapsed time in each altitude change state, and divides the cumulative value of the displacement of the altitude by the cumulative value of the elapsed time in each altitude change state to calculate the average elevating speed.

Further, the consumed calorie calculator 1013 may calculate the consumed calories based on the average elevating speed in each altitude change state calculated by the elevating speed calculator 1012 and the elapsed time. Then, the elevating speed calculator 1012 may display the average elevating speed (for example, average ascending speed) relating to any altitude change state among the calculated average elevating speeds in the display unit 105. Further, when the manipulation signal is repeatedly input from the key input means 104C, the control unit 101 may periodically display the average ascending speed, the average descending speed, and the consumed calories in the display unit 105. If the calculated average ascending speed and consumed calories are stored once in the RAM 110, the average ascending speed and the consumed calories may be not calculated again.

In this way, in the present embodiment, the altitude change determination unit 1011 determines whether the altitude change state is at least the ascending state or the descending state based on the altitude measured by the altitude measurement unit 108, and the elevating speed calculator 1012 calculates the average elevating speed in each altitude change state based on the altitude.

Thus, in the embodiment, the average ascending speed in the ascending state and the average descending speed in the descending state can be distinguishingly calculated.

Further, in the embodiment, the elevating speed calculator 1012 calculates the average elevating speed in each altitude change state, based on the displacement of the altitude in each section where the altitude change state is constant and the elapsed time.

That is, since the average elevating speed can be calculated without calculating the elevating speed, calculation errors generated when the elevating speed is calculated based on the altitude or when the calculated elevating speed is accumulated are not accumulated. Thus, even though the electronic device 10 is configured by small-scaled hardware, the average ascending speed or the average descending speed can be calculated with high accuracy.

### Second Embodiment

Next, a second embodiment of the invention will be described with reference to the accompanying drawings. The same reference numerals are given to the same parts in the respective drawings, and the description will not be repeated.

An electronic device 10a (not shown) according to the second embodiment includes a control unit 101a instead of the control unit 101 of the electronic device 10 (FIG. 2). The control unit 101a includes an elevating speed calculator 1012a instead of the elevating speed calculator 1012 (FIG. 2).

The elevating speed calculator 1012a calculates a moving average of the elevating speed based on the altitudes sampled by the altitude change determination unit 1011, similar to the elevating speed calculator 1012.

The elevating speed calculator 1012a adds (increments) 1 to the number of appearances of the altitude change state indicated by the altitude change state information input from the altitude change determination unit 1011 at that time point to count the number of appearances of each altitude change state. Further, the elevating speed calculator 1012a accumulates the moving average of the calculated elevating speed with respect to the altitude change state to calculate a cumulative value of the elevating speed in each altitude change state.

The elevating speed calculator 1012a divides the cumulative value of the calculated elevating speed by the number of the counted number of appearances to calculate the average elevating speed relating to the altitude change state at that time point.

Next, a data processing according to the present embodiment will be described.

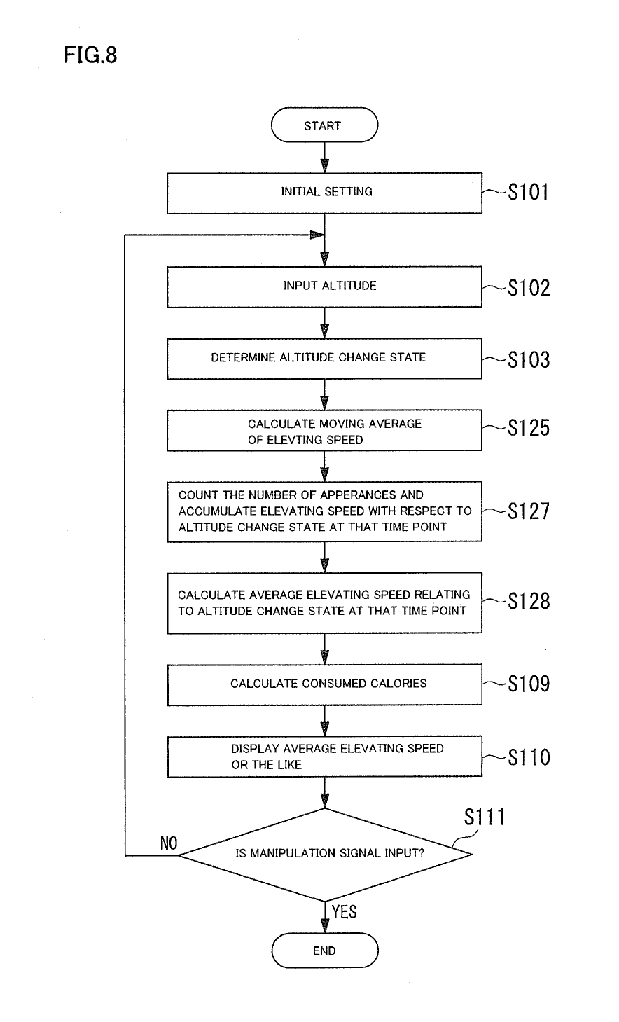

FIG. 8 is a flowchart illustrating the data processing according to the present embodiment.

The data processing according to the second embodiment includes steps S101 to S103 and step S109 to S111, and includes steps S125, S127, and S128, instead of steps S104 to S108 (FIG. 7). In the data processing, after step S103 is finished, the procedure proceeds to step S125.

In step S125, the elevating speed calculator 1012a calculates the moving average of the elevating speed based on the altitudes sampled by the altitude change determination unit 1011. Then, the procedure proceeds to step S127.

In step S127, the elevating speed calculator 1012a adds (increments) 1 to the number of appearances of the altitude change state indicated by the altitude change state information input at that time point, and counts the number of appearances of each altitude change state. Further, the elevating speed calculator 1012a accumulates the moving average of the calculated elevating speed with respect to the altitude change state to calculate a cumulative value of the elevating speed in each altitude change state. Then, the procedure proceeds to step S128.

In step S128, the elevating speed calculator 1012a divides the cumulative value of the calculated elevating speed by the counted number of appearances to calculate the average elevating speed relating to the altitude change state at that time point. Then, the procedure proceeds to step S109.

When the altitude change state at that time point is the non-elevating state, the elevating speed calculator 1012a may omit the process of calculating the cumulative value of the elevating speed, and may set the average elevating speed relating to the non-elevating state to 0.

The elevating speed calculator 1012a may omit the process (step S125) of calculating the moving average of the elevating speed, and may accumulate the elevating speed instead of the moving average (step S127).

In this way, in the present embodiment, the elevating speed calculator 1012a calculates the elevating speed at each predetermined sampling interval based on the altitude measured by the altitude measurement unit 108, and accumulates the calculated elevating speed and the number of appearances with respect to the altitude change state determined by the altitude change determination unit 1011. Further, the elevating speed calculator 1012a calculates the average elevating speed in each altitude change state based on the accumulated elevating speed and the number of appearances. Thus, when calculating the average elevating speed, the elevating speed or the number of appearances in each section where the altitude change state is constant is stored in the RAM 110, so that it is not necessary to read the stored elevating speed or number of appearances. Accordingly, even though small-scaled hardware having limitation in storage capacitance or processing complexity is used, the average ascending speed or the average descending speed can be distinguishingly calculated with high accuracy.

### Third Embodiment

Next, a third embodiment of the invention will be described with reference to the accompanying drawings. The same reference numerals are given to the same parts in the respective drawings, and the description will not be repeated.

An electronic device 10b (not shown) according to the present embodiment includes a control unit 101b instead of the control unit 101a of the electronic device 10a. The control unit 101b includes an elevating speed calculator 1012b instead of the elevating speed calculator 1012a.

The elevating speed calculator 1012b calculates a moving average of the elevating speed based on the altitudes sampled by the altitude change determination unit 1011, similar to the elevating speed calculator 1012a. Further, the elevating speed calculator 1012a counts the number of appearances of each altitude change state, similar to the elevating speed calculator 1012a, accumulates the moving average of the elevating speed in each altitude change state with respect to the altitude change state to calculate a cumulative value, and divides the cumulative value of the calculated elevating speed by the counted number of appearances to calculate the average elevating speed relating to the altitude change state at that time point.

Here, the elevating speed calculator 1012b determines whether the current altitude change state is changed from the immediately previous altitude change state based on the altitude change state information input from the altitude change determination unit 1011. If it is determined that the current altitude change state is changed, until the moving average section ΔT2 elapses from that time point, the elevating speed calculator 1012b stops the process of counting the number of appearances of each altitude change state and the process of accumulating the moving average of the elevating speed in each altitude change state with respect to the altitude change state. Further, when the moving average section ΔT2 elapses, the elevating speed calculator 1012b restarts the process of counting the number of appearances of each altitude change state and the process of accumulating the moving average of the elevating speed in each altitude change state with respect to the altitude change state.

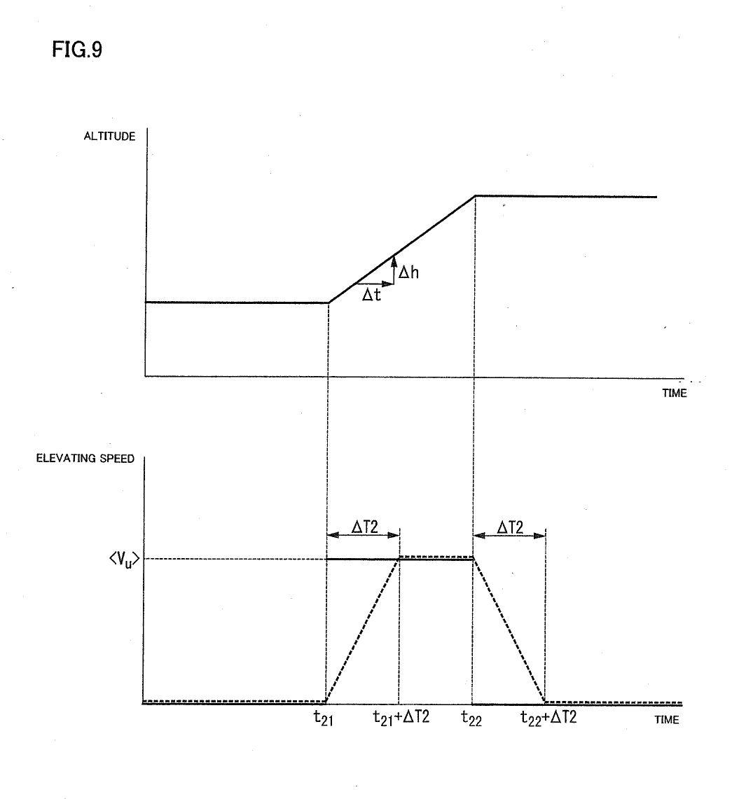

This is because if the elevating speed rapidly changes at the starting point of the moving average section ΔT2, a noticeable error occurs with respect to an actual elevating speed in a part where the elevating speed is smoothened through calculation of the moving average as shown in FIG. 9.

FIG. 9 is a diagram illustrating an example of the moving average of the elevating speed.

In an upper part and a lower part of FIG. 9, the longitudinal axes respectively represent an altitude and an elevating speed. In both the upper part and the lower part, the transverses axes represent time. Solid lines shown in the lower part represent elevating speeds (instantaneous values) obtained based on the altitudes, and dashed lines represent moving averages of the elevating speeds.

In this example, the altitude change state is the non-elevating state before time t₂₁, is changed to the ascending state from the non-elevating state at time t₂₁, and is the ascending state up to time t₂₂. Further, the altitude change state is changed to the non-elevating state from the ascending state at time t₂₂, and then, maintains the non-elevating state as it is.

The instantaneous value of the elevating speed and the moving average are all 0 before time t₂₁. From time t₂₁ to time t₂₂, the instantaneous value of the elevating speed is a constant value “vᵤ”. Meanwhile, from time t₂₁ to time t₂₁+ΔT2, the moving average smoothly increases to “vᵤ” from 0, and then, becomes the constant value “vᵤ” up to time t₂₂. An instantaneous difference in elevating speed is 0 at time after time t₂₂. Meanwhile, from “vᵤ” from t₂₂ to t₂₂+ΔT2, the moving average smoothly decreases to 0, and then, maintains 0 as it is.

Since a moving average section ΔT2 in which the time point when the altitude change state changes is a starting point is a section where the error of the elevating speed is noticeable, the moving average of the elevating speed and the number of appearances in this section are excluded, and thus, the elevating speed calculator 1012b can calculate the average elevating speed with high accuracy.

Next, a data processing according to the present embodiment will be described.

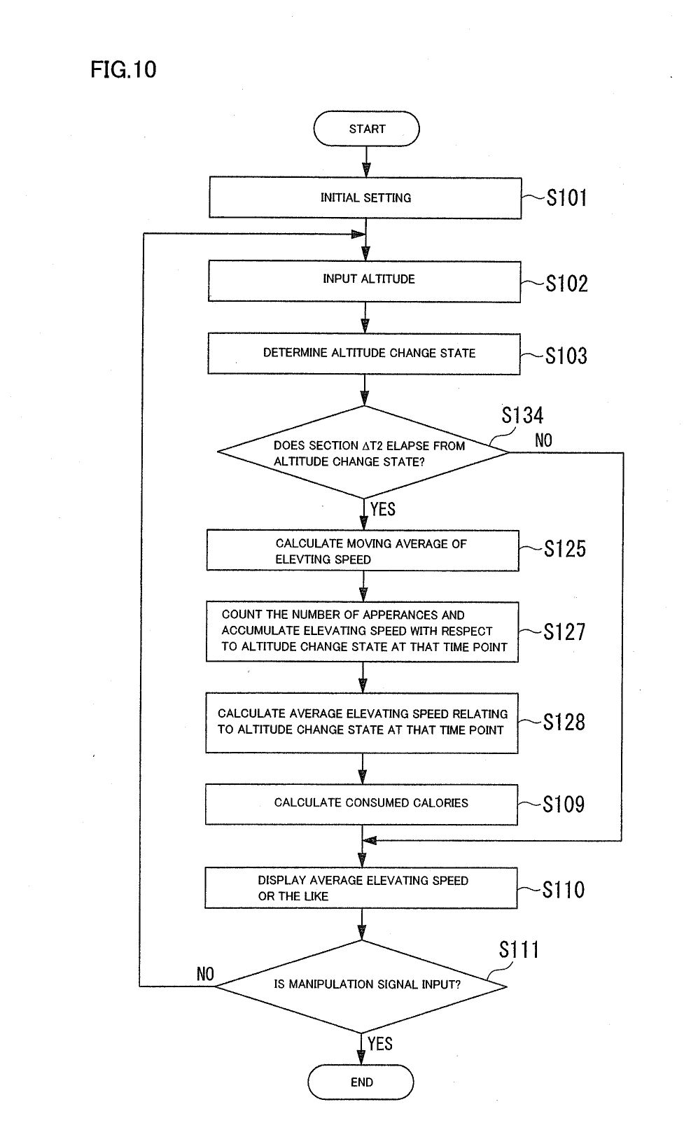

FIG. 10 is a flowchart illustrating the data processing according to the present embodiment.

The data processing according to the present embodiment further includes step S134 in the data processing shown in FIG. 8. In the data processing, after step S103 is finished, the procedure proceeds to step S134.

In step S134, the elevating speed calculator 1012b determines whether the moving average section ΔT2 elapses from the time point when the altitude change state is recently changed based on the altitude change state information input from the altitude change determination unit 1011. If it is determined that the moving average section ΔT2 elapses (Yes in step S134), the procedure proceeds to step S125. If it is determined that the moving average section ΔT2 does not elapse (No in step S134), the procedure proceeds to step S110.

Until the moving average section ΔT2 elapses from the time point when the altitude change state is recently changed, the elevating speed calculator 1012b may continue the counting process of the number of appearances of each altitude change state to count the number of second appearances of each altitude change state. By calculating the product of the number of second appearances and the sampling interval ΔT, the elapsed time according to the determined altitude change state can be obtained. Thus, when calculating an index, like the consumed calories, that demands the elapsed time in each altitude change state, by using the elapsed time based on the number of second appearances, the elapsed time in each altitude change state is compensated, and thus, the accuracy can be maintained.

In this way, in the present embodiment, the elevating speed calculator calculates the moving average of the calculated elevating speed at each sampling interval, and stops the accumulation of the elevating speed until the moving average section elapses after the altitude change state determined by the altitude change determination unit 1011 is changed. Thus, the error due to the smoothing of the elevating speed immediately after the altitude change state is changed is removed, and thus, the average elevating speed can be calculated with high accuracy.

### Fourth Embodiment

Next, a fourth embodiment of the invention will be described with reference to the accompanying drawings. The same reference numerals are given to the same parts in the respective drawings, and the description will not be repeated.

An electronic device 10c (not shown) according to the fourth embodiment includes a control unit 101c instead of the control unit 101a of the electronic device 10a. The control unit 101c includes an altitude change determination unit 1011c instead of the altitude change determination unit 1011.

The altitude change determination unit 1011c samples the altitude indicated by the altitude signal input from the altitude measurement unit 108 at each predetermined sampling interval ΔT, similar to the altitude change determination unit 1011. The altitude change determination unit 1011c determines whether the altitude change state corresponds to a “non-walking state”, in addition to the “ascending state”, the “descending state”, and the “non-elevating state”. The non-walking state refers to a state where a user moves by means other than walking. The non-walking state may appear when the user moves using a transportation system such as a ropeway, a cable car, a railway or an automobile.

Here, when an altitude that is higher than an altitude h+Δg higher than the current altitude h by a predetermined second altitude threshold value Δg is included in the section from the time t−ΔT1 that is the first time interval ΔT1 before the current time to the current time t, or when an altitude that is lower than an altitude h−Δg lower than the current altitude h by a predetermined second altitude threshold value Δg is included in the section from the time t−ΔT1 that is the first time interval ΔT1 before the current time to the current time t, the altitude change determination unit 1011c determines that the altitude change state is the non-walking state. The second altitude threshold value Δg is greater than the above-mentioned (first) altitude threshold value Δh. The former case corresponds to a case where the altitude rapidly descends, and the latter case corresponds to a case where the altitude rapidly ascends. As the second altitude threshold value Δg, a value relating to a speed that is not easily obtained or is not assumed by human's walking may be used (for example, 180 m). Meanwhile, the first altitude threshold value Δh is a value that is acknowledged to have a significant altitude change compared with the measurement error (for example, 5 m).

If it is determined that the altitude change state is the non-walking state, the elevating speed calculator 1012a stops the process of accumulating the moving average of the elevating speed.

The altitude change determination unit 1011c determines the altitude change state as follows, for example.

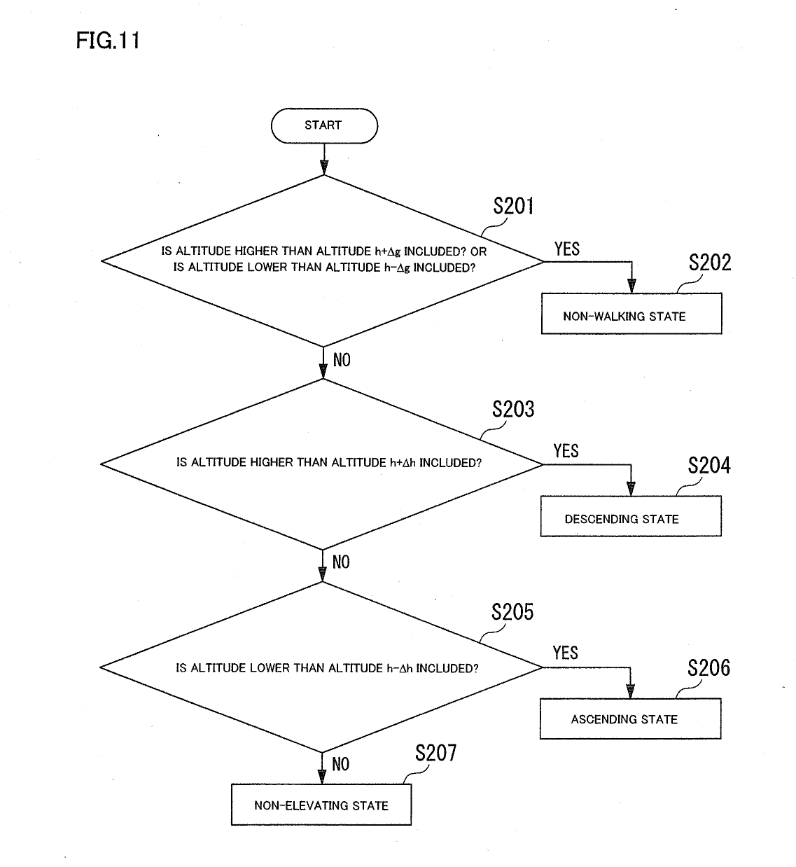

FIG. 11 is a flowchart illustrating the process of determining the altitude change state.

In step S201, the altitude change determination unit 1011c determines whether an altitude that is higher than the altitude h+Δg higher than the current altitude h by the predetermined second altitude threshold value Δg is included in the section from the time t−ΔT1 that is the first time interval ΔT1 before the current time to the current time t, or an altitude that is lower than the altitude h−Δg lower than the current altitude h by the predetermined second altitude threshold value Δg is included therein. If it is determined that the altitude is included therein (Yes in step S201), the procedure proceeds to step S202. If it is determined that the altitude is not included therein (No in step S201), the procedure proceeds to step S203.

In step S202, the altitude change determination unit 1011c determines that the current altitude change state is the non-walking state, and then, the process shown in FIG. 11 is finished.

In step S203, the altitude change determination unit 1011c determines whether an altitude that is higher than the altitude h+Δh higher than the current altitude h by the predetermined first altitude threshold value Δh is included in the section from the time t−ΔT1 that is the first time interval ΔT1 before the current time to the current time t. If it is determined that the altitude is included therein (Yes in step S203), the procedure proceeds to step S204. If it is determined that the altitude is not included therein (No in step S203), the procedure proceeds to step S205.

In step S204, the altitude change determination unit 1011c determines that the current altitude change state is the descending state, and then, the process shown in FIG. 11 is finished.

In step S205, the altitude change determination unit 1011c determines whether an altitude that is lower than the altitude h−Δh lower than the current altitude h by the predetermined first altitude threshold value Δh is included in the section from the time t−ΔT1 that is the first time interval ΔT1 before the current time to the current time t. If it is determined that the altitude is included therein (Yes in step S205), the procedure proceeds to step S206. If it is determined that the altitude is not included therein (No in step S205), the procedure proceeds to step S207.

In step S206, the altitude change determination unit 1011c determines that the current altitude change state is the ascending state, and then, the process shown in FIG. 11 is finished.

In step S207, the altitude change determination unit 1011c determines that the current altitude change state is the non-elevating state, and then, the process shown in FIG. 11 is finished.

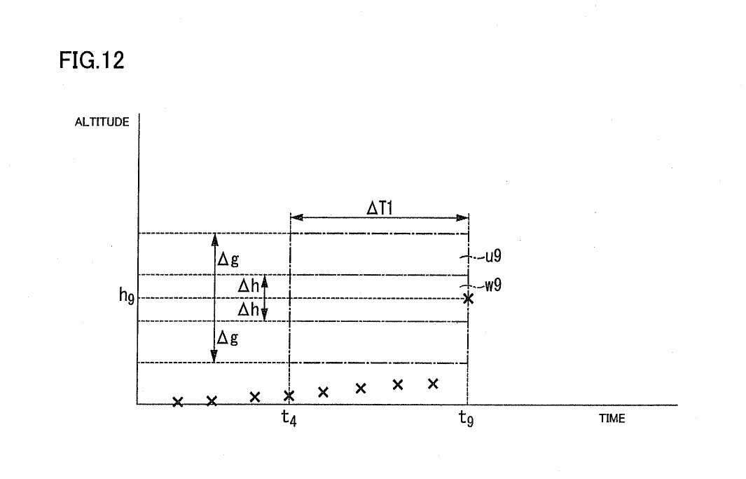

FIG. 12 is a diagram illustrating a setting example of a detection window.

The longitudinal axis and the transverse axis in FIG. 12 represent altitude and time, respectively.

x represents an altitude sampled at each sampling time, a rectangle indicated by a thin one-dot chain line represents a detection window w9, and a rectangle indicated by a thick one-dot chain line represents a detection window u9. In this example, the current time is t₉, in which the altitude rapidly ascends from the immediately previous time t₈ to the current time t₉.

The detection window w9 represents a determination section of which a time range is from t₄ to t₉ and an altitude range is from h₉−Δh to h₉+Δh. Here, h₉ represents the altitude at sampling time t₉. The detection window u9 represents a determination section of which a time range is from t₄ to t₉ and an altitude range is from h₉−Δg to h₉+Δg.

Altitudes h₄ to h₈ at the respective times t₄ to t₈ are distributed below the detection window u9. Accordingly, the altitude change determination unit 1011c determines that the altitude change state at time t₉ is the “non-walking state”.

In comparing the current altitude h with the altitude hₜ−Δ_{T1} at the time t−ΔT1 that is the first time interval ΔT1 before the current time t to determine the altitude change state, when the altitude hₜ−Δ_{T1} is out of the range from the altitude h−Δg to the altitude h+Δg, the altitude change determination unit 1011c may determine that the altitude change state is the “non-walking state”.

For example, when the altitude hₜ−Δ_{T1} is higher than the altitude h-Ah and is lower than the altitude h+Δh, the altitude change determination unit 1011c determines that the altitude change state is the “non-elevating state”, and when the altitude hₜ−Δ_{T1} is within the range from the altitude h−Δg to the altitude h−Δh, the altitude change determination unit 1011c determines that the altitude change state is the “ascending state”. When the altitude hₜ−Δ_{T1} is within the range from the altitude h+Δh to the altitude h+Δg, the altitude change determination unit 1011c determines that the altitude change state is the “descending state”, and when the altitude hₜ−Δ_{T1} is lower than the altitude h−Δg and is higher than the altitude h+Δg, the altitude change determination unit 1011c determines that the altitude change state is the “non-walking state”. If it is determined that the altitude change state is the “non-walking state”, the elevating speed calculator 1012a stops the process of accumulating the moving average of the elevating speed.

Next, a data processing according to the present embodiment will be described.

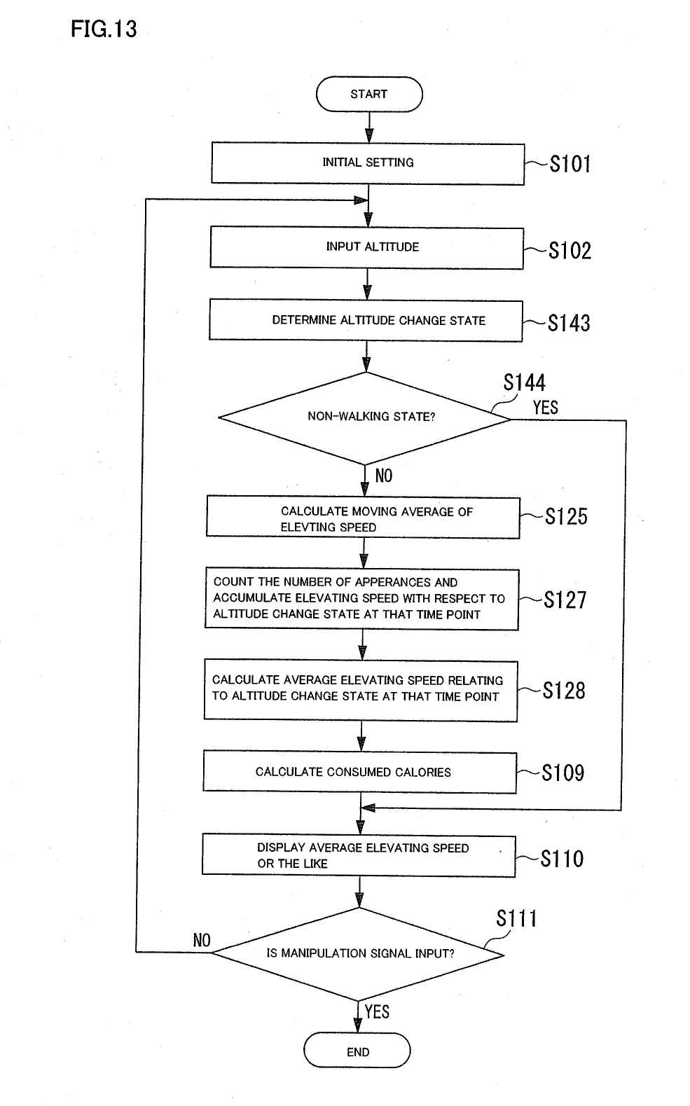

FIG. 13 is a flowchart illustrating the data processing according to the present embodiment.

The data processing according to the present embodiment includes' step S143 instead of step S103 in the data processing shown in FIG. 8, and further includes step S144. In the data processing, after step S102 is finished, the procedure proceeds to step S143.

In step S143, the altitude change determination unit 1011c performs the process of determining the altitude change state (see FIG. 11) based on the altitude change state information input from the altitude change determination unit 1011. Then, the procedure proceeds to step S144.

In step S144, the elevating speed calculator 1012 determines whether the altitude change state determined by the altitude change determination unit 1011c is the non-walking state. If it is determined that the altitude change state is the non-walking state (Yes in step S144), the procedure proceeds to step S110. If it is determined that the altitude change state is not the non-walking state (No in step S144), the procedure proceeds to step S125.

As the process shown in FIG. 13, a case where if it is determined that the altitude change state is the non-walking state, steps S125, S127, S128, and S109 are not executed is described as an example, but the invention is not limited thereto. If it is determined that the altitude change state is the non-walking state, the altitude change state may be considered as the non-elevating state in these steps, so that the process may be performed. That is, in step S127, the elevating speed calculator 1012a may add 1 to the number of appearances of the non-elevating state to count the number of appearances of the non-elevating state, and in step S109, the consumed calorie calculator 1013 may calculate the consumed calories using the elapsed time relating to the non-elevating state based on the counted number of appearances.

The above-described electronic device 10c has the configuration in which the altitude change determination unit 1011c is applied to the electronic device 10a, but the invention is not limited thereto. The electronic device 10c may have a configuration in which the altitude change determination unit 1011c is applied to the electronic device 10b.

In this way, in the present embodiment, when the altitude that is higher than the first altitude range (for example, from h−Δh to h+Δh) including the current altitude (for example, h) is included in the previous altitude within the predetermined determination interval (for example, the first time interval) before the current time and the previous altitude is within the second altitude range (for example, from h−Δg to h+Δg) that is wider than the first altitude range, the altitude change determination unit 1011c determines that the altitude change state is the descending state. Further, when the altitude that is lower than the first altitude range is included in the previous altitude and the previous altitude is included in the second altitude range, the altitude change determination unit 1011c determines that the altitude change state is the ascending state. Further, when the previous altitude is out of the second altitude range, the altitude change determination unit 1011c determines that the state is the non-walking state, and the elevating speed calculator 1012a stops the accumulation of the elevating speed.

Thus, since the elevating speed obtained when the change of the altitude with the lapse of time is noticeably large is not used for calculation of the average elevating speed, the average elevating speed can be calculated with high accuracy. For example, the elevating speed obtained when the user does not walk and moves using a transportation system is ignored when the average elevating speed is calculated.

All or some of the entire functions of the respective units provided in the electronic devices 10, 10a, 10b, and 10c in the above-described embodiments may be realized by recording a program for realizing the functions in a computer-readable recording medium, and allowing a computer system to read the program recorded in the recording medium. Here, the “computer system” includes an operating system (OS) and hardware such as peripheral devices.

Further, the “computer-readable recording medium” refers to a portable medium such as a flexible disk, a magneto-optical disk, a ROM or a CD-ROM, and a storage unit such as a hard disk built in the computer system. Furthermore, the “computer-readable recording medium” may include a medium that dynamically retains the program for a short time, such as a communication line that transmits the program through a network such as the Internet or a communication cable such as a telephone cable, and a medium that retains the program for a certain period of time, such as a volatile memory inside the computer system that serves as a server or a client in this case. In addition, the program may be a program for realizing some of the above-mentioned functions, or may be a program capable of realizing the above-mentioned functions by combination with a program that is recorded in the computer system in advance.

Hereinbefore, the exemplary embodiments of the invention are described, but the invention is not limited thereto, and may include various modifications in a range without departing from the spirit of the invention.

For example, in the above-described embodiments, the number of the key input means included in the manipulation input unit 104 is three, but the invention is not limited thereto. The number of the key input means may be a predetermined number based on the number of the functions of the electronic devices 10, 10a, 10b, and 10c, and for example, may be one or two, or may be greater than three.

Further, in the above-described embodiments, the electronic devices 10, 10a, 10b, and 10c are the electronic watch with the altitude measurement function, but the invention is not limited thereto. The electronic devices 10, 10a, 10b, and 10c may be any electronic device as long as it has the altitude measurement function, for example, may be a multi-function mobile phone (so-called smart phone).

What is claimed is:

1. An electronic device comprising:
an altitude measurement unit that measures an altitude;
an altitude change determination unit that determines whether a change state of the altitude measured by the altitude measurement unit is at least an ascending state or a descending state; and
an elevating speed calculator that calculates an average elevating speed in each change state determined by the altitude change determination unit based on the altitude measured by the altitude measurement unit.

2. The electronic device according to claim 1,
wherein the elevating speed calculator calculates the average elevating speed in each change state based on displacement of an altitude and an elapsed time in each section where the change state determined by the altitude change determination unit is constant.

3. The electronic device according to claim 1,
wherein the elevating speed calculator calculates an elevating speed at each predetermined sampling interval based on the altitude measured by the altitude measurement unit, accumulates the calculated elevating speed and the number of appearances with respect to the change state determined by the altitude change determination unit, and calculates the average elevating speed in each change state based on the accumulated elevating speed and number of appearances.

4. The electronic device according to claim 3,
wherein when an altitude that is higher than a predetermined first altitude range from a current altitude is included in a previous altitude within a predetermined determination interval before a current time and the previous altitude is within a second altitude range that is wider than the first altitude range, the altitude change determination unit determines that the change state is the descending state,
when an altitude that is lower than the first altitude range is included in the previous altitude and the previous altitude is included in the second altitude range, the altitude change determination unit determines that the change state is the ascending state, and
when the previous altitude is out of the second altitude range, the altitude change determination unit stops the accumulation of the elevating speed.

5. The electronic device according to claim 3,
wherein when a previous altitude measured by the altitude measurement unit at a time that is a predetermined time interval before a current time is within a range from an altitude that is lower than a current altitude by a predetermined first altitude to an altitude that is lower than the current altitude currently measured by the altitude measurement unit by a predetermined second altitude, the altitude change determination unit determines that the change state is the ascending state,
when the previous altitude is within a range from an altitude that is higher than the current altitude by the first altitude to an altitude that is higher than the current altitude by the second altitude, the altitude change determination unit determines that the change state is the descending state, and
when the previous altitude is an altitude that is lower than the altitude lower than the current altitude by the second altitude or is an altitude that is higher than the altitude higher than the current altitude by the second altitude, the elevating speed calculator stops the accumulation of the elevating speed.

6. The electronic device according to claim 3,
wherein the elevating speed calculator calculates a moving average of the calculated elevating speed at each sampling interval, and stops the accumulation of the elevating speed until a moving average section elapses after the change state determined by the altitude change determination unit is changed.

7. A data processing method in an electronic device, comprising:
determining whether a change state of an altitude measured by an altitude measurement unit is at least an ascending state or a descending state; and
calculating an average elevating speed in each change state determined in the determining of the altitude change based on the altitude measured by the altitude measurement unit.

8. A data processing program that causes a computer of an electronic device to execute a procedure comprising:
determining whether a change state of an altitude measured by an altitude measurement unit is at least an ascending state or a descending state; and
calculating an average elevating speed in each change state determined in the determining of the altitude change based on the altitude measured by the altitude measurement unit.
